(19) United States
(12) Patent Application Publication
(10) Pub. No.: US 2026/0074919 A1
(43) Pub. Date: Mar. 12, 2026

(54) SYSTEM AND METHOD FOR BLOCKCHAIN-BASED VERIFICATION OF CERTIFICATES OF AUTHENTICATION IN SUPPLY CHAIN MANAGEMENT

(71) Applicants: Michael Coner, Lighthouse Point, FL (US); Ian Kimmel, Carmel, IN (US)

(72) Inventors: Michael Coner, Lighthouse Point, FL (US); Ian Kimmel, Carmel, IN (US)

(21) Appl. No.: 19/322,145

(22) Filed: Sep. 8, 2025

Related U.S. Application Data
(60) Provisional application No. 63/691,795, filed on Sep. 6, 2024.

(51) Int. Cl. H04L 9/32; G06Q 20/36; G06Q 20/38

(52) U.S. Cl. CPC H04L 9/3268; G06Q 20/3672; G06Q 20/389

(57) ABSTRACT

A blockchain-based system and method for verifying Certificates of Authentication (COAs) in supply chain management is disclosed, adhering to ASTM D8558-24 guidelines and relevant ISO standards including ISO/IEC 27001, ISO 28000, and ISO 9001. The system utilizes a custom Layer 1 (L1) blockchain built on the Avalanche platform, implementing a dual-token model to create, manage, and verify COAs as Non-Fungible Tokens (NFTs). It features AI-powered authentication, enhanced security measures, and a data marketplace for monetizing authenticated supply chain data. The system offers improved scalability, customization for various industries, and facilitates both B2B and B2C transactions. With cross-chain communication capabilities and integration with existing supply chain systems, the invention addresses environmental and social considerations while providing comprehensive interoperability. This solution aims to revolutionize supply chain authentication, offering enhanced transparency, efficiency, and trust in global trade, all while maintaining compliance with international standards for security, quality, and supply chain management.

### CROSS-REFERENCE TO RELATED APPLICATION

This application claims the priority, under 35 U.S.C. § 119(e), of provisional patent application No. 63/691,795, filed Sep. 6, 2024; the prior application is herewith incorporated by reference in its entirety.

### FIELD OF THE INVENTION

This invention relates to a custom Layer 1 (L1) blockchain technology system for creating, securing, and verifying Certificates of Authentication (COAs) used to track products through their supply chain, as outlined in ASTM D8558-24. The system employs a dual-token model and integrates advanced artificial intelligence and machine learning capabilities to enhance authentication processes and data insights generation.

This application claims the priority, under 35 U.S.C. § 119(e), of provisional patent application No. 63/691,795, filed Sep. 6, 2025; the prior application is herewith incorporated by reference in its entirety.

### BACKGROUND

The authenticity of products must be tracked along a supply chain. A manufacturer may purchase certain raw goods from a supplier. That supplier supplies goods from certain sources. The manufacturer is informed of a source of the supplied goods, however, there has been no uncompromisable way to assess an actual source. This issue can be compounded when the supply chain has more intermediaries and/or intermediate production or processing. That is, sourcing over a long supply chain or supply chains with a high degree of specificity are susceptible to fraud and mistakes along the way and must be tracked. Current blockchain solutions, while offering improvements over traditional systems, often face scalability issues and struggle to provide the level of customization required for complex supply chain authentication needs.

Additionally, many existing systems lack the capability to efficiently generate and utilize valuable insights from the vast amount of data collected through the authentication process. Furthermore, the integration of blockchain technology with supply chain processes often presents challenges in terms of user adoption, particularly for traditional businesses unfamiliar with cryptocurrency operations.

There is a pressing need for a solution that bridges the gap between conventional supply chain management and advanced blockchain capabilities, while also leveraging the power of artificial intelligence and machine learning to enhance data analysis and fraud detection.

### Terminology

The invention uses terminology consistent with ASTM D8558-24 (and in accordance with Terminology D8270 unless otherwise indicated), including definitions for blockchain, certificate of authentication, NFTs, and other relevant terms.

Block, n—in blockchain technology, refers to the list of records, also known as transactions, bundled together with a predetermined size and linked to the previous block.

Blockchain, n—a decentralized and distributed digital ledger technology recording transactions across numerous computers. The recorded data cannot be altered retroactively, ensuring transparency and security in data management.

Certificate of authentication, n—a Certificate of Authentication (COA) is a document provided by an authoritative source that verifies the authenticity of an item. This certificate serves as a seal of assurance, indicating that the item in question is genuine and not a forgery or counterfeit.

Discussion—COAs are commonly used in the art world, collectibles market, and other areas where authenticity is paramount. Typically, a COA will include specific details about the item, such as its origin, any unique characteristics, the name of the authenticator, and possibly a unique serial number.

Cryptocurrency, n—a type of digital or virtual currency using cryptography for security. Operates independently of a central bank, typically based on blockchain technology.

Decentralization, n—refers to the distribution of functions, powers, people, or things away from a central location or authority. In blockchain, it signifies no single entity having control over the entire network.

Digital currency, n—a decentralized digital currency, without a central bank or single administrator. It can be sent from user to user on the peer-to-peer Digital Currency network without intermediaries.

Distributed ledger, n—a database existing across several locations or among multiple participants. In blockchain technology, it enables transactions to have public “witnesses”, reducing the need for trust.

ERC—721, n-ethereum request for comments (ERC) 721 is a data standard for creating non fungible tokens, meaning each token is unique and cannot be divided or directly exchanged for another ERC-721 token. The ERC-721 standard allows creators to issue unique crypto assets like NFTs via smart contracts.

ERC-1155, n—ERC-1155 is a multi-token standard on the Ethereum blockchain. It was designed to enable a single smart contract to manage multiple token types, both fungible and non-fungible.

gas, n—in blockchain, a unit measuring the amount of computational effort required to execute certain operations in the blockchain network.

Hash, n—in blockchain, a function converting an input of letters and numbers into an encrypted output of a fixed length.

Immutable, adj—immutability is the ability of a blockchain ledger to remain unchanged, unaltered, and memorable. Each of the blocks of information, like facts or transaction details, is carried out with the help of a cryptographic principle or a hash value.

Ledger, n—in blockchain, a ledger is a record of all completed transactions.

Metadata, n—metadata describes just attributes of the NFT, attributes like trait type, company name, product type, date of test and unique identifier of that test.

Mining, v—in blockchain technology, the process of adding transaction records to the blockchain's public ledger using computer processing power.

NFTs, n—non-fungible tokens (NFTs) are unique digital assets representing ownership of specific items or pieces of content. Unlike cryptocurrencies, which are fungible and interchangeable, NFTs are distinct and not exchangeable on a one-for-one basis.

Node, n—in blockchain, any computer connecting to the blockchain network.

Private key, n—in blockchain technology, a sophisticated form of cryptography allowing users to access their cryptocurrency.

Proof of stake, n—a type of consensus mechanism used by blockchain networks to achieve distributed consensus. It requires users to show ownership of a certain number of cryptocurrency tokens.

Proof of work, n—a consensus algorithm in a block-chain network used to confirm transactions and produce new blocks to the chain.

Public key, n—in blockchain technology, a crypto-graphic code allowing users to receive cryptocurrencies into their accounts.

Smart contracts, n—self-executing contracts with the terms of the agreement between parties coded directly into them. Stored and replicated on the blockchain, they are supervised by the network of computers running the block-chain.

Token, n—a type of cryptocurrency representing as-sets or utility and residing on its own blockchain. Tokens can represent any tradable goods or assets.

Tracking devices, n—tracking device for COAs on the blockchain refers to tools, such as RFID, QR codes, or micro transponders, utilized to monitor and verify the authenticity of products connected to the COA by physically attaching these tracking devices to the products by unit, batch or lot as it moves through the supply chain.

Trustless, adj—trustlessness is fundamental to block-chain technology, eliminating the need for intermediaries like banks or central authorities in transactions.

Discussion—This means individuals can engage in crypto payments and smart contracts directly with others, without relying on a third party's integrity or security. Essentially, it empowers individuals with full control and assurance in their cryptocurrency dealings.

Wallet, n—in blockchain, a digital place where a user stores their cryptocurrency.

### Non-Fungible Tokens

Non-fungible tokens (“NFTs”) are unique digital assets stored on a blockchain. They are created using smart contracts, which are self-executing agreements with the terms of the contract directly written into code. This code is responsible for managing the ownership, transfer, and other rules associated with each specific NFT. NFTs are typically based on token standards like ERC-721 and ERC-1155, which define a set of rules and functions for creating, managing, and transferring non-fungible tokens on a blockchain. Each NFT has a unique identifier, which ensures its individuality and allows it to be differentiated from other tokens.

When an NFT is created, it is assigned metadata, which contains information about the digital asset it represents. This metadata can include details like the name, description, creator, client name, unique test identifier and image or file associated with the asset. The metadata is typically stored off-chain, while a hash of the metadata is stored on the blockchain to verify its authenticity.

A blockchain is a decentralized, distributed digital ledger that records transactions across multiple computers, ensuring that the data is secure, transparent, and tamper-resistant. The blockchain is made up of a series of connected blocks, each containing a list of transactions. When a new transaction occurs, it is added to the most recent block. Once a block is full, a new block is created and linked to the previous one, forming a chain.

One of the key features of blockchain technology is its consensus mechanism, which ensures that all participating nodes agree on the content and order of transactions. This process makes it extremely difficult for anyone to alter or manipulate the data stored on the blockchain, providing a secure and trustworthy record of transactions and digital assets.

As the first blockchain to introduce smart contracts, blockchain is the most widely adopted platform for NFTs. It supports multiple token standards, including ERC-721 and ERC-1155, which provide a framework for creating and managing non-fungible tokens. Many well-known NFT marketplaces, like OpenSea3 and Rarible4, operate on the blockchain network.

ERC-721 is the first and most widely used standard for non-fungible tokens on the blockchain. It was proposed by Dieter Shirley in 2018 as a way to create unique, indivisible tokens that can represent ownership of digital or physical assets. ERC-721 tokens are distinguishable from one another, meaning each token has a unique identifier that cannot be replicated or replaced by another token. The standard defines a set of functions that allow developers to create, transfer, and manage ownership of ERC-721 tokens. Some of these functions include:

Mint—Creates a new ERC-721 token and assigns ownership to a specified address.

Owner Of—Returns the owner of a specific ERC-721 token.

Transfer From—Transfers ownership of an ERC-721 token from one address to another.

Approve—Grants permission for a specified address to transfer a specific ERC-721 token on behalf of the current owner.

ERC-1155 is a more recent and versatile NFT standard proposed by Enjin in 2018. It combines the best features of ERC-20 (fungible tokens) and ERC-721 (non-fungible tokens) standards, allowing for the creation of both fungible and non-fungible tokens within a single smart contract. This feature reduces the complexity and gas costs associated with managing multiple token types. Like ERC-721, ERC-1155 tokens have unique identifiers, but they also have an additional attribute called “ID”, which is used to group tokens with similar characteristics. This allows for the efficient management and transfer of multiple tokens in a single transaction. Some key functions defined in the ERC-1155 standard include:

Safe Transfer From—Transfers a specific ERC-1155 to-ken from one address to another, ensuring that the receiving address is compatible with the token standard.

Balance Of—Returns the balance of a specific ERC-1155 token for a specified address.

Set Approval For All—Grants or revokes permission for a specified address to manage an owner's ERC-1155 tokens.

While ERC-721 and ERC-1155 are the most well-known NFT standards, other token standards have emerged to address specific needs and use cases in the NFT space:

ERC-998—This standard extends the functionality of ERC-721 and allows for the creation of “composable” NFTs. Composable NFTs can own other ERC-721 or ERC-20 tokens, enabling complex relationships between digital assets and the creation of nested ownership structures.

ERC-1046—This standard proposes an extension to the ERC-721 standard that allows for the inclusion of token metadata directly within the smart contract. This can help simplify the process of verifying the authenticity of an NFT's metadata.

### NFT Metadata and Attributes

Components of NFT Metadata is the information that describes the unique characteristics of an NFT and differentiates it from other tokens. The metadata usually includes attributes such as name, description, image, and other proper-ties specific to the NFT's use case. For instance, a digital art NFT might have metadata detailing the artist's name, creation date, and artwork dimensions.

Metadata is typically structured in JSON format, making it easily accessible and readable by both humans and machines. Some common components of NFT metadata include:

Token ID—A unique identifier that distinguishes the NFT from others.

Name—The name of the NFT or the asset it represents.

Description—A brief description of the NFT or the asset.

Image—A URL pointing to the image, video, or other media associated with the NFT.

External URL—A link to an external website with more information about the NFT or its asset.

Attributes—Additional properties specific to the NFT's use case, such as rarity, level, or edition number.

### How Metadata is Stored on the Blockchain

Storing the complete metadata directly on the blockchain can be expensive due to the associated gas costs. Therefore, most NFTs store their metadata off-chain, while the blockchain only stores a unique identifier and a reference to the metadata's location. One form of a URL or a content-addressable storage system is the Inter Planetary File System (IPFS). IPFS is a decentralized storage system that ensures the metadata remains accessible and tamper-proof even if the original server hosting the data goes offline.

Metadata can include information about the NFT's origin and ownership history, allowing potential buyers to verify its provenance and ensure it was legitimately created by the stated artist or creator.

Importance of Metadata in Authentication plays a crucial role in the authentication process of NFTs. Authenticating an NFT involves verifying the integrity of its metadata to ensure that the token represents the intended asset and has not been tampered with or manipulated. Some ways in which metadata is essential for NFT authentication include:

Uniqueness—The metadata's unique identifier helps confirm that an NFT is distinct from others, ensuring that collectors are purchasing a one-of-a-kind asset.

Asset Representation—Metadata stores the information that represents the NFT's associated asset, such as an image or video. Verifying the integrity of this data helps ensure that the NFT accurately represents its asset and has not been altered or misrepresented.

Smart Contract Interaction—Metadata can include information on how to interact with the NFT's underlying smart contract, such as token standards, contract addresses, or additional functions. Verifying this data ensures that the NFT functions correctly within the blockchain ecosystem.

NFT metadata is an essential component for authenticating non-fungible tokens. Ensuring the integrity and accuracy of metadata helps protect collectors and creators from fraud, misrepresentation, and potential legal disputes.

### Digital Signatures

Digital signatures are cryptographic techniques used to verify the authenticity and integrity of digital data, such as messages, documents, and transactions. In the context of NFTs, digital signatures help prove the origin and authenticity of the token and its associated metadata. They enable creators to sign their work, allowing collectors to confirm the legitimacy of an NFT and its creator.

Digital signatures use public-key cryptography, which relies on a pair of keys: a public key and a private key. The private key is kept secret by the owner, while the public key is freely shared with others. The process of creating a digital signature involves the following steps:

The creator generates a cryptographic hash of the data they want to sign (for example, the NFT metadata).

The creator uses their private key to encrypt the hash, creating a digital signature.

The digital signature is then attached to the data and shared with others.

To verify the authenticity of the data and its digital signature, a recipient performs the following steps: The recipient generates a cryptographic hash of the received data.

The recipient uses the creator's public key to decrypt the attached digital signature, revealing the original hash.

The recipient compares the generated hash with the decrypted hash. If they match, it proves the data's integrity and that it was signed by the creator.

Digital signatures play a critical role in NFT authentication by ensuring the legitimacy and integrity of the token and its metadata. Some specific ways in which digital signatures are involved in NFT authentication include:

Creators can use digital signatures to sign their NFTs and associated metadata, proving that they are the original creators of the token and its asset.

Digital signatures can be used to verify the integrity of NFT metadata. If any part of the data is altered, the signature will no longer match, alerting recipients to potential tampering or forgery.

Digital signatures can help establish trust between creators, collectors, and other participants in the NFT ecosystem. By proving that an NFT was created and signed by a specific individual or organization, collectors can be more confident in the authenticity of their purchases.

Digital signatures can be used to sign transactions involving NFTs, such as transfers or sales. This helps ensure the security and validity of transactions within the NFT market.

Digital signatures are a vital aspect of NFT authentication, as they help ensure the legitimacy and integrity of tokens, their metadata, and transactions within the NFT ecosystem. By leveraging digital signatures, creators, collectors, and other participants can establish trust and protect against fraud, forgery, and tampering.

Layer 1 (L1), n—a base blockchain that can validate and finalize transactions without relying on another network. In this invention, it refers to the custom blockchain built on the Avalanche platform.

BTIC Token, n—the utility token of the Blockticity network used for governance, staking, and accessing premium features within the ecosystem.

BCOA Token, n—a USD-pegged stablecoin used for minting COAs and facilitating everyday transactions within the Blockticity ecosystem.

### SUMMARY OF THE INVENTION

It is therefore an object of the present invention to provide a custom Layer 1 (L1) blockchain-based system for creating, managing, and verifying Certificates of Authentication (COAs) as Non-Fungible Tokens (NFTs), adhering to the guidelines set forth in ASTM D8558-24. This innovative system addresses the critical needs for enhanced security, scalability, and data utilization in supply chain authentication.

The invention comprises a custom L1 blockchain built on platform, such as the the Avalanche platform, offering superior scalability, speed, and customization for supply chain authentication needs. This L1 solution enables efficient handling of large volumes of COAs across various industries.

Central to the system is a dual-token model featuring BTIC (Blockticity Token), a utility token used for governance, staking, and accessing premium features, and BCOA (Blockticity COA Token), a USD-pegged stablecoin facilitating everyday transactions and COA minting. This model bridges traditional business operations with advanced blockchain capabilities, simplifying adoption for non-crypto-native users.

### BRIEF DESCRIPTION OF THE DRAWINGS

FIG. 1 shows a system architecture overview of the Blockticity L1 ecosystem, including its interaction with the Avalanche platform and key components.

FIG. 2A-D illustrates the COA minting process, detailing the steps from data receipt to NFT issuance.

FIG. 3A-C depicts the authentication process, showcasing the AI-powered review steps and decision points.

FIG. 4A-C presents the token interaction model, demonstrating the flow and utility of BTIC and BCOA tokens within the ecosystem.

FIG. 5 shows the data access tiers, illustrating how BTIC holdings correspond to different levels of data access.

### DETAILED DESCRIPTION OF THE INVENTION

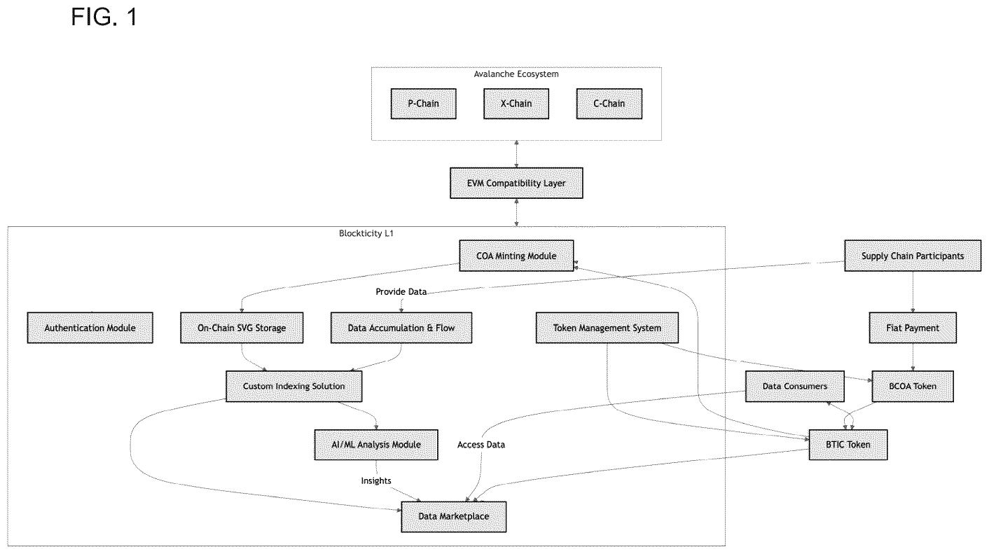

FIG. 1 shows a system architecture overview of the Blockticity L1 ecosystem and its interaction with the Avalanche platform. Here, the high-level architecture of the Blockticity system for verifying Certificates of Authentication (COAs) in supply chain management is shown. In a preferred embodiment, the Blockticity L1 is built on the Avalanche Ecosystem as a foundation. The Blockticity Custom L1 is the core blockchain layer of the system. The system uses a Dual-Token System: Depicting BTIC (utility token) and BCOA (stablecoin). The system utilizes four key modules: a. COA Minting Module, b. AI-Powered Authentication Module, c. Data Marketplace, and d. Token Management System. The system also utilizes external integrations: a. Supply Chain Participants, b. Data Consumers, and c. Existing Supply Chain Systems. Further, the system can utilize a cross-chain communication; as seen in FIG. 1, interoperability with other blockchain networks. The arrows in the diagram represent data flow and interactions between different components of the system.

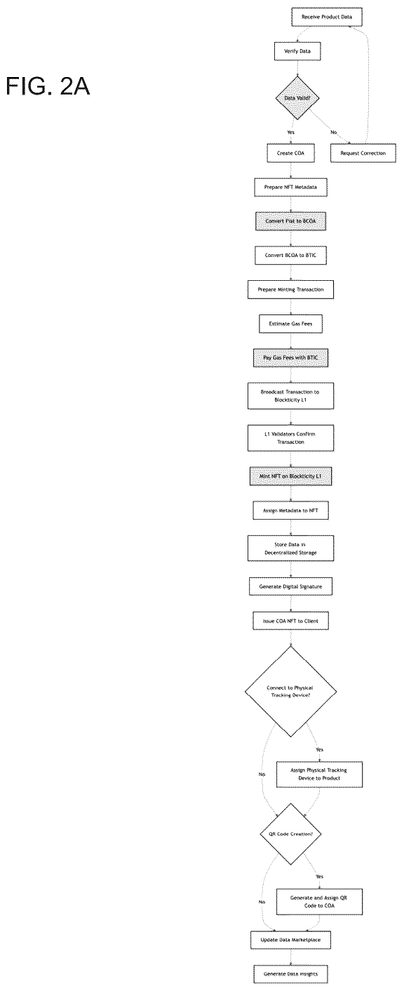

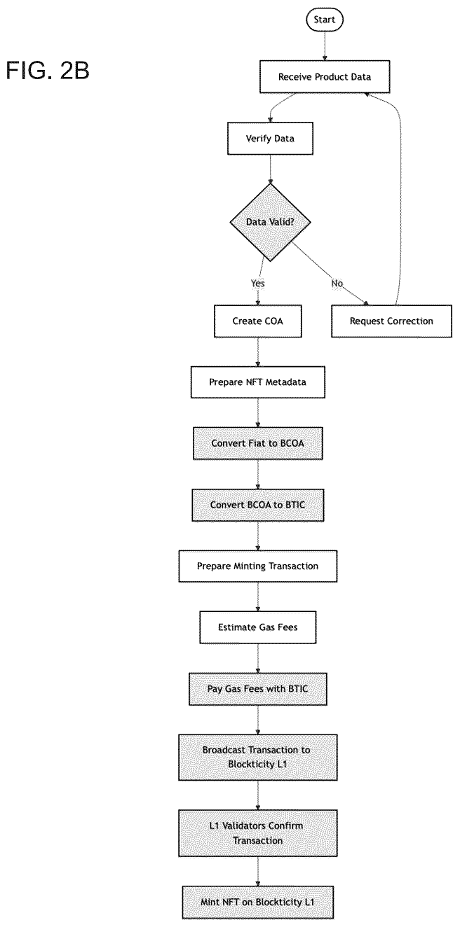

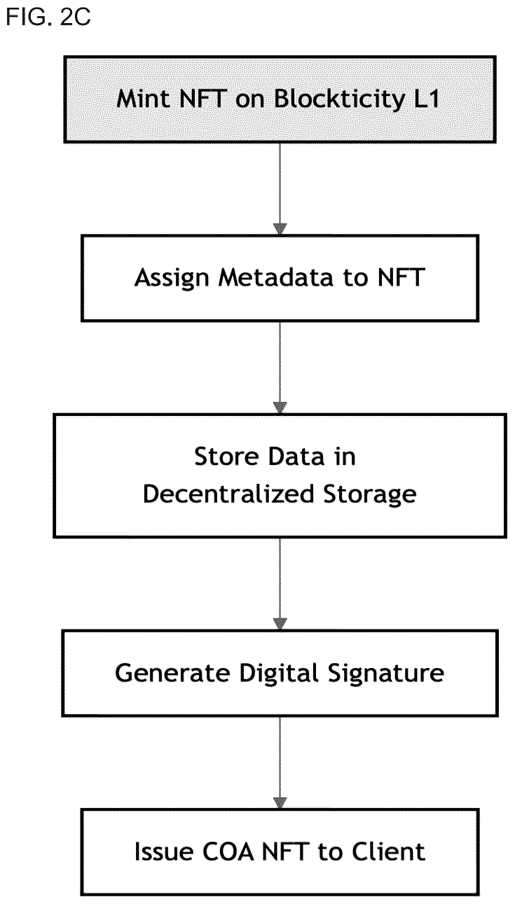

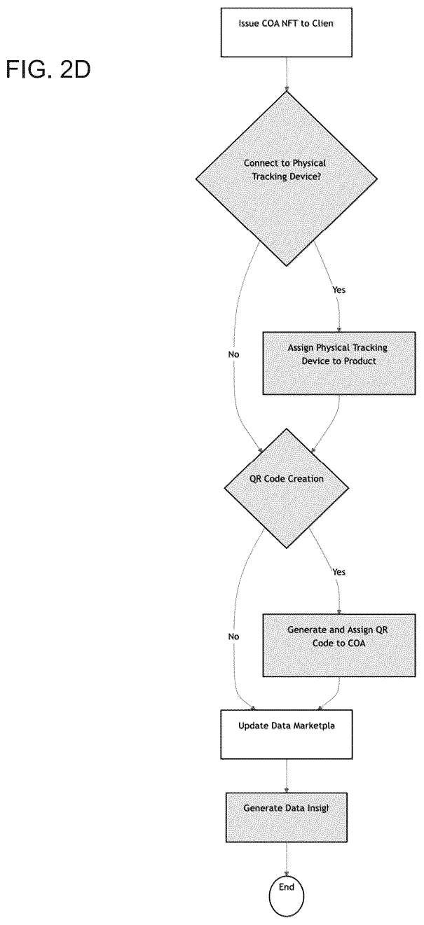

FIG. 2A illustrates the COA minting process, detailing the steps from data receipt to NFT issuance. FIG. 2B highlights the process steps from start to the minting of the NFT. FIG. 2C highlights the process steps from minting of the NFT to Issuing the COA NFT to the client. FIG. 2D highlights optional steps and insights of the process steps. Here, the process flow for minting a Certificate of Authentication (COA) as a Non-Fungible Token (NFT) on the Blockticity L1 blockchain is shown. The key steps of the process the following:
1. Data Reception and Validation;
2. COA Creation and NFT Metadata Preparation;
3. Token Conversion (Fiat to BCOA to BTIC);
4. Transaction Preparation and Gas Fee Estimation;
5. Transaction Broadcast and Validation on Blockticity L1;
6. NFT Minting and Metadata Assignment;
7. Data Storage and Digital Signature Generation;
8. COA NFT Issuance to Client;
9. Optional Physical Tracking Device Assignment;
10. Optional QR Code Generation;
11. Data Marketplace Update; and
12. Data Insights Generation.

The flowchart uses different shading and shapes to distinguish between standard processes, decision points, token-related operations, and L1-specific actions. Dashed lines indicate optional steps in the process.

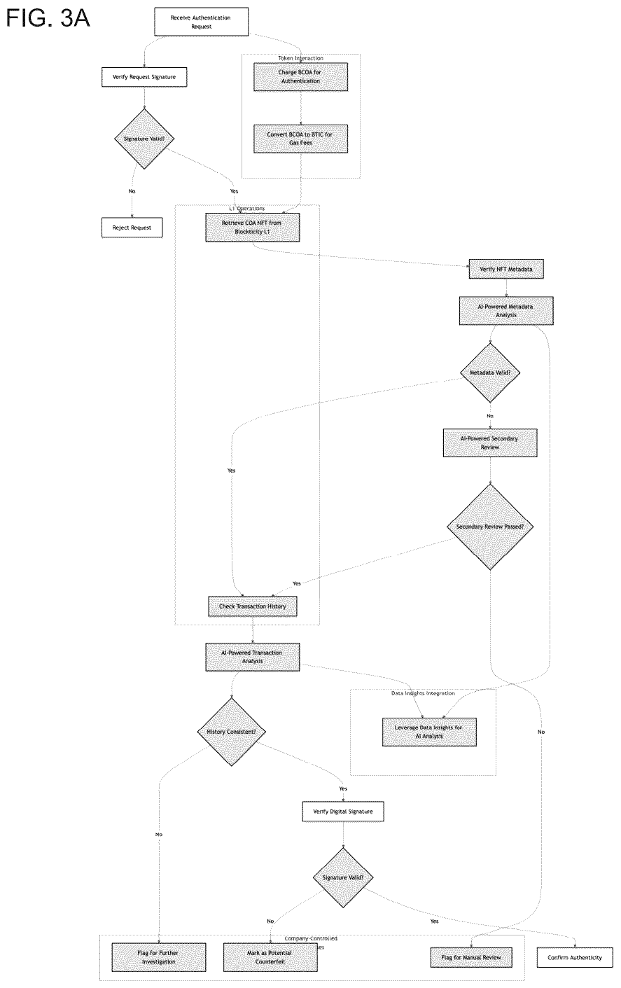

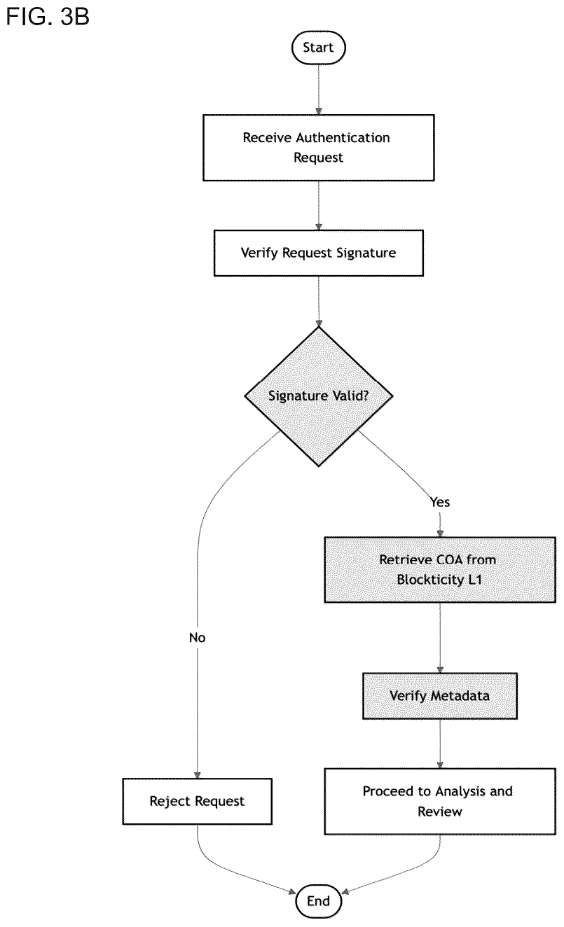

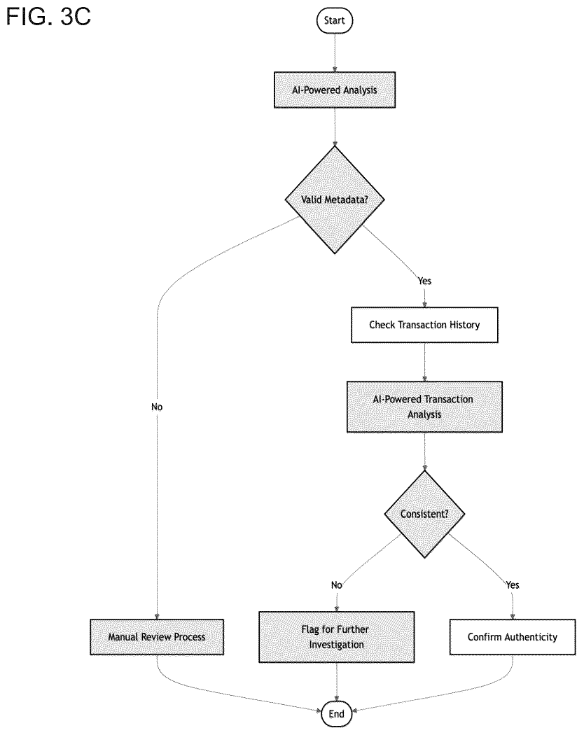

FIG. 3A depicts the authentication process, showcasing the AI-powered review steps and decision points. FIG. 3B highlights the core authentication steps of the process and FIG. 3C highlights the AI-powered and manual review process. Here, the detailed process flow for minting a Certificate of Authentication (COA) as a Non-Fungible Token (NFT) on the Blockticity L1 blockchain of the AI-powered embodiment is shown. The flowchart depicts the following key steps:
1. Data Reception and Validation;
2. COA Creation and NFT Metadata Preparation;
3. Token Conversion (Fiat to BCOA to BTIC);
4. Transaction Preparation and Gas Fee Estimation;
5. Transaction Broadcast and Validation on Blockticity L1;
6. NFT Minting and Metadata Assignment;
7. Data Storage and Digital Signature Generation;
8. COA NFT Issuance to Client;
9. Optional Physical Tracking Device Assignment;
10. Optional QR Code Generation;
11. Data Marketplace Update; and
12. Data Insights Generation.

The flowchart uses different shading and shapes to distinguish between standard processes, decision points, token-related operations, and L1-specific actions. Dashed lines indicate optional steps in the process.

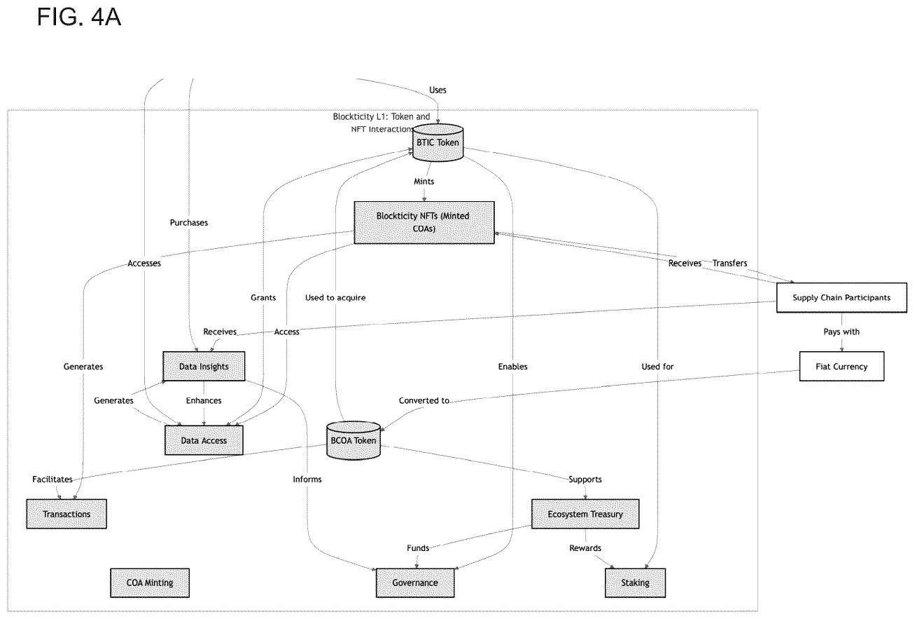

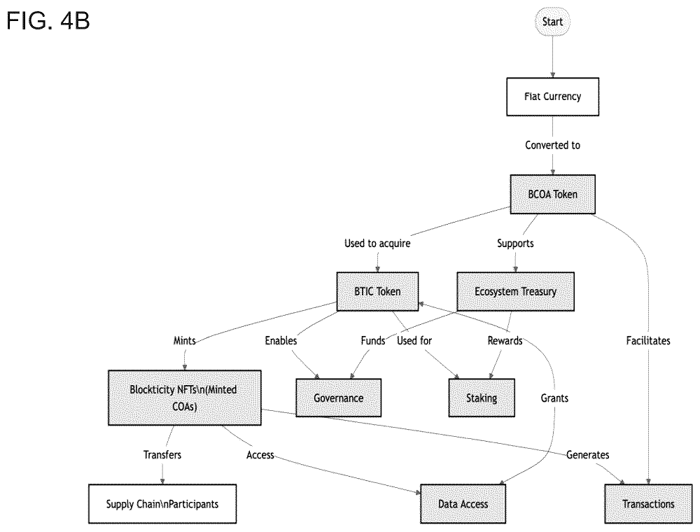

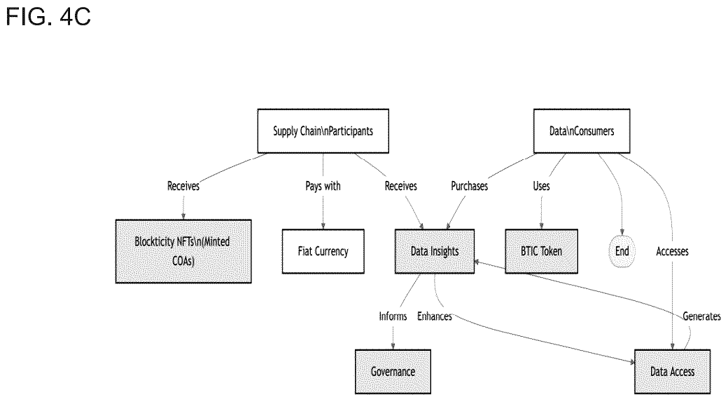

FIG. 4A presents the token interaction model, demonstrating the flow and utility of BTIC and BCOA tokens within the ecosystem. FIG. 4B highlights core token and NFT interactions, and FIG. 4C highlights data flow and external interactions. Here, the comprehensive token interaction model within the Blockticity L1 ecosystem is shown. This flowchart depicts the relationships and flows between various components of the system, including:
1. Token Components:
   BTIC Token (utility token)
   BCOA Token (stablecoin)
   Blockticity NFTs (minted COAs)
2. System Functions:
   COA Minting
   Transactions
   Governance
   Staking
   Data Access
   Ecosystem Treasury
   Data Insights Generation
3. External Entities:
   Fiat Currency
   Supply Chain Participants
   Data Consumers
Key Interactions:
   Conversion flow from Fiat to BCOA to BTIC
   BTIC token usage for minting NFTs, governance, and staking
   BCOA token role in facilitating transactions and supporting the treasury
   NFT transfers and data access rights
   Data insights generation and its impact on governance and data access
   External participants' interactions with the system

The model, as seen in FIG. 4, demonstrates the intricate relationships within the Blockticity L1 ecosystem, highlighting how the dual-token system (BTIC and BCOA) interacts with NFTs and various system functions to create a comprehensive and efficient platform for supply chain authentication and data management. The flowchart uses different shading and shapes to distinguish between tokens, system components, and external entities. Arrows indicate the direction of token flow, data flow, and interactions between different elements of the ecosystem.

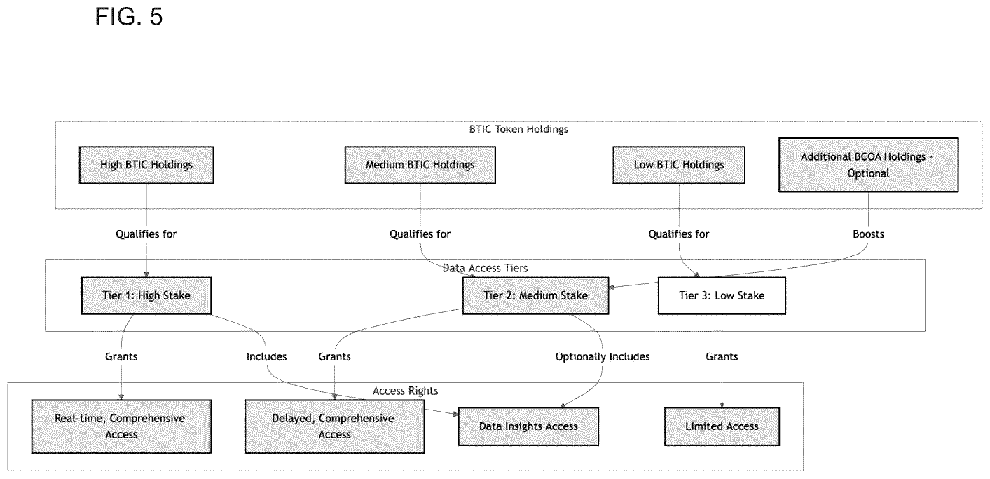

FIG. 5 shows the data access tiers, illustrating how BTIC holdings correspond to different levels of data access. Here, the tiered data access system within the Blockticity ecosystem, demonstrating how BTIC token holdings correspond to different levels of data access is shown. The flowchart depicts the following key components:
1. Data Access Tiers:
   Tier 1: High Stake
   Tier 2: Medium Stake
   Tier 3: Low Stake
2. Access Rights:
   Real-time, Comprehensive Access
   Delayed, Comprehensive Access
   Limited Access
   Data Insights Access
3. BTIC Token Holdings:
   High BTIC Holdings
   Medium BTIC Holdings
   Low BTIC Holdings
   Additional BCOA Holdings (Optional)
Key Features:
   Direct correlation between BTIC token holdings and access tier qualification
   Graduated access rights corresponding to each tier
   Optional boost to access rights through additional BCOA holdings
   Special emphasis on Data Insights Access for higher tiers

This tiered system incentivizes higher BTIC holdings by offering enhanced data access and insights, creating a value-driven ecosystem that rewards active participation and investment in the Blockticity platform. The flowchart uses different shading and styles to distinguish between tiers, access rights, and token holdings. Arrows indicate the relationships between holdings, tiers, and the corresponding access rights.

The system can be implemented across various industries, each with its unique requirements. Below are examples of how the Blockticity L1 system can be applied in different sectors, adhering to the guidelines set forth in ASTM D8558-24.

### 1. Scientific Laboratory Report Authentication

In an embodiment, a database of COAs is collected from a DEA certified lab and metadata is added to each NFT in the minting process like Name of lab, name of client, date of COA issuance and accession unique identifier. Once the COA has been minted, a QR Code is generated to make it searchable with a simple smartphone click to view the report on chain and verify it has not been uploaded by another source to sell an imposter imitation product.

This implementation aligns with ASTM D8558-24 guidelines by:

Utilizing blockchain technology to create unique digital certificates (NFTs) for COAs, as outlined in Section 4.1 of the standard.

Implementing blockchain timestamps to provide an immutable and verifiable record of the COA's origin and authenticity, as described in Section 4.2.

Following the authentication process outlined in Section 4.3, including examining the NFT's smart contract, verifying metadata, confirming digital signatures, and checking transaction history.

Storing metadata off-chain with a hash on the blockchain for verification, as suggested in Section 5.3.

Generating QR codes for easy verification, aligning with the standard's emphasis on accessibility and trust-building among participants.

### 2. Agricultural Supply Chain Verification

In another embodiment, the Blockticity system can be utilized to monitor compliance with import standards. For example, the system can ensure over 1000 Colombian coffee farmers exporting more than 11.6 million bags of green bean equivalent (GBE) coffee per year comply with the European Union's Deforestation Regulation (EUDR). This initiative aims to guarantee fair trade practices and sustainability in the coffee supply chain by leveraging blockchain's transparency and security.

The process involves:

### a) Data Collection and Initial Processing:

A secure web portal is developed for farmers and cooperatives to submit coffee lot information.

The Blockticity L1's capabilities are utilized for initial data processing and verification, enhancing efficiency.

The web portal uses Vue.js for front-end development, creating an intuitive UI/UX that allows farmers to submit detailed information about their coffee lots, including origin, cultivation practices, and compliance documents.

Server-side processing using Laravel PHP validates submission accuracy and completeness before processing, including checks against pre-defined criteria to ensure EUDR compliance from the outset.

### b) Compliance Verification:

Machine learning algorithms are implemented off-chain to verify each coffee batch's compliance with EUDR criteria, focusing on sustainability and ethical standards.

The system employs advanced data preparation, feature engineering, and model selection techniques to translate complex EUDR regulations into quantifiable metrics.

Continuous learning mechanisms are implemented to allow the system to adapt to evolving regulations and agricultural practices.

### c) On-Chain Certification:

Immutable digital certificates of authenticity (CoAs) are created for EUDR-compliant coffee batches, anchored on the Blockticity L1 with unique hashes and timestamps.

Detailed certificate data is stored off-chain but verifiable through the blockchain, maintaining privacy and data integrity.

### d) Supply Chain Integration and Monitoring:

Buyers and supply chain stakeholders can verify coffee batch authenticity and compliance through blockchain-stored hashes.

On-chain analytics are leveraged to monitor supply chain flow and compliance, providing detailed sustainability reports.

This implementation adheres to ASTM D8558-24 by:

Creating unique digital certificates (NFTs) for COAs on the Blockticity L1, as outlined in Section 4.1 of the standard.

Implementing blockchain timestamps to provide an immutable and verifiable record of each coffee batch's origin and EUDR compliance, as described in Section 4.2.

Following the authentication process outlined in Section 4.3, including smart contract examination, metadata verification, digital signature confirmation, and transaction history checks.

Storing detailed certificate data on-chain with a hash on the blockchain for verification, as suggested in Section 5.3, ensuring both data privacy and integrity.

Enabling easy verification for buyers and stakeholders, aligning with the standard's emphasis on accessibility and trust-building among participants.

Utilizing AI and machine learning for compliance verification, extending beyond the basic requirements of the standard to provide more robust and adaptive authentication.

The Blockticity L1 system in this implementation not only meets the ASTM D8558-24 guidelines but also enhances them through advanced technology integration, providing a comprehensive solution for agricultural supply chain verification and EUDR compliance.

### System Architecture

In a preferred embodiment, the Blockticity System Architecture comprises:

(a) A custom Layer 1 (L1) blockchain platform built on Avalanche, offering enhanced In this embodiment, the Blockticity system is utilized to ensure over 1000 Colombian coffee farmers exporting more than 11.6 million bags of green bean equivalent (GBE) coffee per year comply with the European Union's Deforestation Regulation (EUDR). This initiative aims to guarantee fair trade practices and sustainability in the coffee supply chain by leveraging blockchain's transparency and security.scalability and customization for supply chain authentication needs.

(b) A dual-token model featuring BTIC (utility token) and BCOA (stablecoin) to facilitate various operations within the ecosystem.

(c) An advanced tool for minting Certificates of Authentication (COAs) as Non-Fungible Tokens (NFTs).

(d) An AI-powered verification system for authenticating COAs.

(e) Integration capabilities with various tracking devices (RFID, QR codes, holograms, etc.).

### Key Components:

### 1. Custom L1 Blockchain:

Built on the Avalanche platform, providing high throughput and low latency.

Enables horizontal scaling, allowing each blockchain to operate independently and be customized for specific use cases.

Supports smart contracts compliant with standards similar to ERC-721 or ERC-1155, adapted for the Avalanche platform.

### 2. Dual-Token System:

BTIC Token: Used for governance, staking, and accessing premium features.

BCOA Token: A USD-pegged stablecoin for minting COAs and facilitating everyday transactions.

### 3. COA Minting Module:

Creates and issues COAs as unique NFTs on the Blockticity L1.

Assigns metadata including lab name, client name, date of issuance, and unique identifiers.

Implements blockchain timestamps for immutable record-keeping.

### 4. AI-Powered Authentication Module:

Employs machine learning algorithms for automated primary and secondary reviews of COA metadata.

Conducts advanced transaction analysis and fraud detection.

Follows a multi-step authentication process including smart contract examination, metadata verification, digital signature confirmation, and transaction history checks.

### 5. Data Marketplace:

Allows for secure access, sharing, and monetization of authenticated supply chain data.

Implements a tiered access system based on BTIC token holdings.

### Verification Process:

Verification of COAs should be assessed by authorized parties in accordance with applicable regulations. The system supports the implementation of a verification plan based on risk assessment, identifying assets and data to be protected, and addressing threats throughout the supply chain process. The verification measures are categorized into three key areas:
1. Physical Security:
   Integration with tracking devices (RFID, QR codes, micro transponders) for physical product tracking.
   Support for secure storage of hard copies and associated samples.
2. Technical Security:
   Blockchain-based protection of digital COA records.
   Implementation of cryptographic techniques for data integrity and authenticity.
   Off-chain storage of detailed data with on-chain hash verification.
   3. Administrative Security:
   Support for policy implementation, protocol management, and lifecycle oversight.
   Features for regular audits, training, and role-based access control.

The Blockticity system is designed to be flexible and adaptable, allowing for customization of security measures based on the value and sensitivity of the assets being tracked. By leveraging blockchain technology, AI, and a dual-token model, the system provides a comprehensive solution for supply chain authentication that aligns with and exceeds industry standards such as ASTM D8558-24.

### COA Creation and Minting Process

In the Blockticity system, the COA creation and minting process comprises: receiving product data and creating a COA, minting the COA as an NFT on the Blockticity L1 blockchain, assigning unique identifiers and metadata, implementing digital signatures for security, and utilizing the dual-token model for minting and gas fees. the process in detail:
1. Data Reception and COA Creation:
   The system receives product data through secure channels, such as the web portal developed for clients.
   AI-powered algorithms verify the data for completeness and compliance with relevant standards (e.g., EUDR for coffee exports).
   A digital COA is created based on the verified data.
2. NFT Design and Preparation:
   The system generates a digital representation of the COA, which may include text, images, or other relevant digital assets.
   The design ensures clear presentation of crucial information while maintaining the uniqueness of each COA.
3. Minting Process:
   The COA is minted as an NFT on the Blockticity L1 blockchain.
   The process utilizes smart contracts compliant with standards similar to ERC-721 or ERC-1155, adapted for the Avalanche platform.
   Minting fees, or “gas fees,” are paid using the BCOA token, providing a stable, predictable cost for users.
4. Unique Identifier and Metadata Assignment:
   Each NFT is assigned a unique token ID on the Blockticity L1 blockchain.
   Metadata is associated with the NFT, including:
   Name of the issuing lab or authority
   Client name
   Date of COA issuance
   Unique sample or batch identifier
   Relevant compliance information (e.g., EUDR compliance for coffee)
   A hash of the metadata is stored on-chain, with detailed information securely stored off-chain, balancing transparency with data privacy.
5. Digital Signature Implementation:
   The system applies a digital signature to the NFT and its metadata.
   This signature, created using advanced cryptographic techniques, proves the COA's origin and authorship.
6. Blockchain Recording:
   The minting process records the initial ownership of the NFT on the Blockticity L1 blockchain.
   A blockchain timestamp is applied, providing an immutable record of the COA's creation time.
7. QR Code Generation:
   A QR code is generated, linking to the on-chain COA information.
   This allows for easy verification of the COA using a smartphone or other devices.

The minting process on the Blockticity L1 plays a crucial role in COA authentication by:
i. Assigning a unique token ID, ensuring the COA's uniqueness and scarcity.
ii. Storing a hash of the metadata on-chain, making it immutable and tamper-proof while maintaining data privacy.
iii. Implementing digital signatures to prove origin and authorship.
iv. Establishing a transparent and verifiable record of the COA's provenance through blockchain recording.

By leveraging the Blockticity L1 blockchain and the dual-token model, this process ensures each COA is unique, securely associated with a specific product or batch, and has an immutable record on the blockchain. The use of BCOA for gas fees provides stability and predictability in the minting process, making it more accessible for traditional businesses.

This enhanced COA creation and minting process not only ensures authenticity and traceability but also offers improved efficiency and cost-effectiveness compared to traditional systems or general-purpose blockchain platforms.

### Authentication Process

In the Blockticity system, the authentication process for Certificates of Authentication (COAs) comprises: a) AI-powered preliminary analysis, (b) examination of the NFT's smart contract, (c) verification of the NFT's metadata, (d) confirmation of digital signatures, and (e) checking of transaction history.

### Authentication Tools and Services:

1. Avalanche Block Explorer:
   As Blockticity's L1 is built on Avalanche, any Avalanche block explorer can be used to view chain data, including COA NFT details, smart contracts, and transaction histories.
2. Blockticity Data Insights Marketplace:
A platform where token holders can request custom data insights derived from the metadata of authenticated COAs.
This marketplace focuses on providing valuable supply chain intelligence rather than trading NFTs.
3. Third-Party Integration:
APIs for third-party services to integrate Blockticity's authentication process into their systems.
4. Backend AI/Machine Learning Applications:
   Advanced AI and machine learning algorithms operate on the backend to enhance the authentication process and generate valuable insights.
   These applications are not user-facing but significantly improve the system's ability to detect fraud, analyze trends, and provide detailed supply chain intelligence.

The Blockticity authentication process leverages the immutability and transparency of blockchain technology, enhanced by AI-powered analysis and the security of the dual-token model. By utilizing BTIC for staking and BCOA for transaction fees, the system provides a stable and efficient environment for COA authentication.

This comprehensive approach ensures the integrity of COAs, builds trust among supply chain participants, and protects the value of physical assets. The combination of Avalanche's robust blockchain infrastructure, Blockticity's advanced AI analysis, and the potential for human expert review provides a multi-layered authentication process that exceeds traditional verification methods.

Further embodiments can include a mobile verification app, further enhancing the accessibility and usability of the Blockticity system for on-the-go authentication needs.

### Authenticating COA NFTs on the Blockticity L1 Blockchain

In a preferred embodiment, the Blockticity system is configured to protect COA NFTs and ensure their authenticity. As blockchain-based supply chain authentication grows, safeguarding these digital assets becomes increasingly crucial. The Blockticity L1, built on Avalanche, implements several methods to protect COA NFTs and prevent counterfeits, combining traditional techniques with advanced blockchain technology.

Digital Watermarking and Cryptographic Techniques: Watermarking, a technique that involves embedding a visible or invisible mark into a digital asset, is enhanced in the Blockticity system. Each COA NFT is minted with both a traditional watermark and a unique cryptographic signature. The watermark helps identify the owner of the asset and discourages unauthorized use, while the cryptographic signature serves as a tamper-proof digital fingerprint.

2. Access Control and Digital Rights Management (DRM): Blockticity implements robust access control mechanisms and DRM tools, which control the access and distribution of digital content. These are managed through smart contracts on the L1 blockchain, ensuring that only authorized parties can interact with the COAs in specified ways. This combination of watermarking, cryptographic signatures, and DRM helps protect COA NFTs from unauthorized use and reproduction.

3. Intellectual Property Protection: Understanding copyright and intellectual property (IP) laws is crucial in the context of COA NFTs. When a COA is created in the Blockticity system, it clearly defines the associated rights. The creator retains the copyright to the work, while the entity receiving the COA typically acquires a license to use the content in specific ways. Clear terms and conditions are provided for each COA, ensuring all parties understand their rights and responsibilities.

4. Counterfeit Prevention Measures: To mitigate the risk of encountering counterfeit COAs, Blockticity implements several security measures:
i. Provenance Verification: Users can carefully examine the COA NFT's smart contract, metadata, digital signature, and transaction history to ensure its authenticity.
ii. Creator Verification: For high-value or sensitive COAs, the system integrates additional steps to confirm the legitimacy of the issuing authority.
iii. AI-Powered Fraud Detection: Blockticity's backend AI systems continuously monitor for suspicious activity, flagging potential counterfeits for investigation.
iv. Secure Marketplace: While Blockticity doesn't operate a traditional NFT marketplace, its Data Insights Marketplace incorporates built-in verification and authentication mechanisms for secure transactions of data derived from COAs.

5. Security Best Practices: The system encourages users to follow security best practices, including: using strong passwords and enabling two-factor authentication; being cautious when clicking links or downloading files related to COAs; and keeping private keys safe and secure

6. Data Integrity and Immutability: Leveraging the Avalanche blockchain's immutability, once a COA is minted and recorded, it cannot be altered or deleted, ensuring long-term data integrity.

7. Tiered Access to Metadata: Blockticity implements a tiered system for accessing the detailed metadata associated with each COA, balancing transparency with necessary confidentiality in supply chain data.

By employing this comprehensive approach that combines traditional security methods with advanced blockchain and AI technologies, Blockticity ensures the protection and authenticity of COA NFTs. This not only preserves the value and integrity of the digital assets but also maintains the trustworthiness of the entire supply chain authentication process. The system's design focuses on creating a secure, transparent, and efficient ecosystem for managing Certificates of Authentication across various industries.

### L1 Implementation on Avalanche

In a preferred embodiment, the Blockticity system is configured as a custom Layer 1 (L1) blockchain built on the Avalanche platform. This L1 implementation provides (a) customizable privacy settings, (b) enhanced regulatory compliance, (c) optimized performance for specific industries, and (d) seamless integration with the broader Avalanche ecosystem.

Blockticity's L1, leveraging Avalanche's technology, is revolutionizing the way developers create and interact with blockchains and decentralized applications (dApps) in Web3, particularly for supply chain authentication and management. This custom-built, optimized blockchain addresses the rising demand for faster, cheaper transaction environments and provides a compelling alternative to high-fee smart contract platforms. When a Certificate of Authenticity (COA) is created (or “minted”) on Blockticity's L1, it becomes a unique Non-Fungible Token (NFT) with special features tailored to supply chain needs.

Developers can enjoy customizable privacy, deciding which parts of the COA's information (or “metadata”) are public, such as the product's name and origin, and which parts remain private, safeguarding sensitive business details. This offers the best of both worlds: the security and trustworthiness of blockchain with the added benefits of privacy, speed, and cost-efficiency, all tailored precisely to a business's needs. Blockticity's L1 transforms the blockchain experience by offering an express lane for transactions and the ability to create a more efficient, cost-effective, and customized system.

Blockticity's L1 offers significant value for businesses globally through increased scalability and efficiency. It allows for horizontal scaling, following the Internet's architecture. In this model, each blockchain operates independently and can be customized for specific use cases. Unlike traditional monolithic blockchains that scale vertically, Blockticity's L1 does not share resources with other organizations, thus improving scalability.

With this L1 implementation, businesses can optimize their network for their specific needs in terms of performance, regulatory compliance, and ecosystem rules. Enterprises can create permissioned environments, controlling participation and ensuring regulatory compliance with specifications like KYC, SOC 2, and accredited investor certifications. This flexibility makes Blockticity's L1 suitable for various industries including traditional finance, medicine, government, and more.

While L1 implementations like Blockticity's offer numerous advantages, they also come with certain challenges including: ensuring sufficient decentralization through validator participation; developing effective cross-chain communication protocols; and competing with other blockchain ecosystems in the supply chain space.

Addressing these challenges requires sourcing and incentivizing validators to participate in the ecosystem. Cross-chain communication also poses a challenge, with ongoing technological improvements needed to make cross-chain messaging practical at scale.

Blockticity L1 may further include: additional services to make customization even easier and more affordable; improvements in validator sourcing and incentives; enhanced cross-chain interoperability; and integration with emerging technologies like IoT for enhanced product tracking.

Blockticity's L1 implementation on Avalanche offers a promising solution to scaling blockchain-based supply chain authentication for mainstream adoption. By providing developers and businesses with a flexible, customizable environment, Blockticity can potentially revolutionize the way innovative applications are built on blockchain platforms, particularly in the realm of supply chain management and product authentication. The success of this L1 solution will depend on its ability to onboard businesses, create interoperability standards, and effectively solve real-world supply chain challenges.

### Security Measures

In Blockticity's preferred embodiment, the system is configured to implement:
(a) Advanced cryptographic techniques and digital rights management
(b) Role-based access control
(c) Immutable ledger for transaction records
(d) AI-powered fraud detection and prevention

The growing adoption of blockchain in supply chain management has led to an increased need for robust authentication and security measures. Authenticating COA NFTs in Blockticity's ecosystem is crucial for several reasons:
i. Establishing Clear Ownership: Authentication of COA NFTs helps establish a clear chain of ownership, ensuring that the digital asset has not been tampered with or counterfeited. This provenance is essential for maintaining the value and integrity of the supply chain data.
ii. Building Trust: Ensuring the authenticity of COA NFTs builds trust in the ecosystem, making it more attractive for both producers and consumers. Trust is fundamental to any successful supply chain, and authentication plays a significant role in fostering that trust.
iii. Value Preservation: By verifying the authenticity of COA NFTs, stakeholders can be confident that they are dealing with legitimate, unique digital assets. This assurance helps preserve the value of the COA, especially for high-value or sensitive products.
iv. Intellectual Property Protection: Authentication helps protect manufacturers' and brands' intellectual property rights and ensures that COA NFT users are obtaining legitimate access to the associated supply chain data.

As Blockticity's system continues to evolve, further approaches to authentication and security are implemented:
i. Enhanced Standards: Blockticity develops new and enhanced standards for COA NFTs, leading to improved security and authentication processes. These standards make it significantly more challenging for counterfeiters to create fake COAs.
ii. Decentralized Authentication: Blockticity's L1 implementation provides a blockchain-based, decentralized authentication system, offering an additional layer of security and trust. This enables more transparent and verifiable authentication processes.
iii. AI and Machine Learning: Blockticity employs advanced AI and machine learning algorithms to analyze patterns and detect counterfeit COA NFTs efficiently. These systems continuously learn and adapt, helping to protect the integrity of the supply chain data.
iv. Physical-Digital Asset Linkage: For COA NFTs representing authenticity of physical assets, Blockticity develops secure authentication mechanisms that robustly link the digital and physical worlds. This is particularly important for industries like luxury goods, pharmaceuticals, and high-value electronics.
v. Industry Collaboration: Blockticity actively participates in industry-wide collaborations among blockchain platforms, supply chain participants, and technology providers. These collaborations aim to develop standardized authentication protocols and best practices, further enhancing security and trust in the COA NFT ecosystem.

Authenticating COA NFTs is essential for maintaining trust, value, and legal protection in the rapidly growing field of blockchain-based supply chain management. As Blockticity's ecosystem continues to evolve, new and innovative approaches to authentication and security are continuously developed and implemented, ensuring the long-term success and stability of this transformative technology in supply chain authentication.

### Supply Chain Integration

In Blockticity's preferred embodiment, the system is configured to support: (a) B2B transactions (inbound and outbound transfers); (b) B2C transactions (retail sales); (c) Integration with existing inventory management systems; and (d) End-to-end supply chain traceability.

Blockticity's L1 blockchain solution facilitates comprehensive supply chain integration, ensuring transparency, efficiency, and security throughout the entire process.

### B2B Transactions:

### Inbound Transfers (Receiving):

When goods are received, the system creates a COA NFT representing the incoming shipment.

The receiving business verifies the authenticity of the shipment by checking the COA NFT on Blockticity's blockchain.

Once verified, the system updates the inventory and links the COA NFT to the recipient's account.

This process ensures accurate recording of received goods and maintains an unbroken traceability chain.

### Outbound Transfers (Shipping):

When preparing to ship goods, the system generates a new COA NFT for the outbound shipment, linking it to the original inbound COA NFTs.

The outbound COA NFT includes details such as products, quantities, destination, and any relevant compliance information.

Once the transfer is committed on the blockchain, it becomes available for the recipient to verify and accept.

This structured approach ensures all transfer details are accurately recorded and traceable throughout the journey.

### 2. B2C Transactions (Retail Sales):

In retail scenarios, Blockticity's system supports the creation of consumer-facing COA NFTs.

These COAs can be linked to specific products or batches, allowing consumers to verify the authenticity and origin of their purchases.

For loyalty program members, the system can associate purchases with their accounts, enhancing customer engagement and enabling personalized experiences.

3. Integration with Existing Systems:

Blockticity's platform offers robust APIs for seamless integration with existing inventory management and ERP systems.

This allows businesses to leverage their current infrastructure while benefiting from blockchain-based authentication and traceability.

The system supports real-time data exchange, ensuring that inventory levels and transaction records are always up-to-date across all integrated platforms.

### 4. End-to-End Supply Chain Traceability:

Blockticity's L1 solution provides a comprehensive view of the entire supply chain, from raw materials to end consumers.

Each stage of the product journey is recorded as a COA NFT, creating an immutable chain of custody.

This enables stakeholders to trace the origin of products, verify compliance with regulations, and quickly identify any issues in the supply chain.

5. Role-Based Access Control (RBAC):

The system implements a sophisticated RBAC system, built on the Casbin library, to manage permissions and access control.

This ensures that only authorized personnel can access, modify, or transfer COA NFTs and related data, maintaining data integrity and confidentiality.

### 6. Data Management and Integrity:

All core data related to transactions and COAs is stored on Blockticity's L1 blockchain, ensuring immutability and transparency.

The system employs advanced cryptographic techniques to protect sensitive information while still allowing for verifiable authenticity checks.

By implementing this comprehensive supply chain integration, Blockticity provides a robust platform that enhances operational efficiency, ensures product authenticity, and promotes trust among all participants in the supply chain ecosystem. The seamless flow of authenticated information from manufacturers to end consumers creates a transparent and reliable supply chain, addressing key challenges in modern commerce such as counterfeiting, traceability, and regulatory compliance.

### Environmental and Social Considerations

In Blockticity's preferred embodiment, the system addresses: (a) energy-efficient consensus mechanisms; (b) promotion of supply chain transparency; (c) protection of individual rights through immutable records; (d) sustainable and ethical supply chain practices.

Environmental Considerations: Blockticity's L1 solution, built on the Avalanche platform, inherently addresses the environmental concerns associated with traditional blockchain technologies. Unlike energy-intensive mining processes used in some platforms, Blockticity leverages Avalanche's energy-efficient Proof-of-Stake (PoS) consensus mechanism. This approach significantly reduces the system's carbon footprint compared to Proof-of-Work systems.

Key environmental benefits include:
1. Lower Energy Consumption: The PoS mechanism requires far less computational power, resulting in reduced energy use.
2. Scalability Without Environmental Cost: Blockticity's system can scale to handle millions of COAs without a proportional increase in energy consumption.
3. Encouraging Sustainable Practices: By providing transparent supply chain data, Blockticity enables businesses and consumers to make more environmentally conscious decisions.

Social Implications: Blockticity's implementation of blockchain technology has several positive social implications:
1. Equitable Distribution of Power: The decentralized nature of the system promotes a more balanced distribution of authority in supply chains, challenging traditional hierarchies.
2. Financial Inclusion: While Blockticity primarily focuses on supply chain management, its blockchain infrastructure can support decentralized finance (DeFi) applications, potentially enabling greater financial inclusion for underserved populations.
3. Combating Unethical Practices: Blockticity's system excels in verifying product authenticity and tracing supply chains. This capability is crucial in:
   Combating child labor and unfair trade practices
   Ensuring compliance with labor standards and fair wage practices
   Verifying the authenticity of sustainable and ethically sourced products

4. Protecting Individual Rights: The immutable nature of Blockticity's blockchain records can be leveraged to protect various individual rights:
Securing property ownership records
Safeguarding intellectual property rights
Ensuring fair compensation for work throughout the supply chain

5. Empowering Consumers: By providing transparent and verifiable information about products, Blockticity empowers consumers to make informed decisions aligned with their values.

6. Supporting Sustainable Development Goals (SDGs): Blockticity's system can be instrumental in tracking and verifying progress towards various SDGs, particularly those related to responsible production and consumption.

Balancing Benefits and Challenges: While Blockticity's system offers numerous benefits, it's important to address potential challenges:
1. Digital Divide: To mitigate the risk of exacerbating digital divides, Blockticity is committed to developing user-friendly interfaces and providing educational resources to ensure accessibility for all stakeholders.
2. Data Privacy: While promoting transparency, Blockticity also implements robust data protection measures to safeguard sensitive information and individual privacy rights.
3. Ethical Use of Technology: Blockticity is committed to the responsible development and deployment of its technology, adhering to ethical guidelines and promoting fair use throughout the supply chain ecosystem.

Blockticity's implementation of blockchain technology for supply chain management represents a significant step towards a more sustainable and equitable future. By addressing both environmental concerns through energy-efficient mechanisms and social issues through enhanced transparency and rights protection, Blockticity is contributing to the development of more responsible and ethical global supply chains. As the system continues to evolve, ongoing assessment and adaptation will ensure that Blockticity remains at the forefront of sustainable and socially responsible blockchain solutions.

### Interoperability

In Blockticity's preferred embodiment, the system is configured to implement: (a) Cross-chain communication capabilities; (b) Integration with blockchain explorers and data marketplaces; (c) Seamless interaction with existing supply chain management systems; and (d) Compatibility with IoT devices and other emerging technologies.

1. Cross-Chain Communication Capabilities: Blockticity's L1 solution, built on the Avalanche platform, is designed to facilitate efficient cross-chain communication:

Avalanche Bridge Integration: Leveraging Avalanche's bridge technology, Blockticity enables secure and efficient transfer of assets and data between its L1 and other major blockchain networks, including Ethereum and Bitcoin.

Inter-Subnet Communication: Within the Avalanche ecosystem, Blockticity's L1 can communicate with other subnets, allowing for specialized supply chain solutions to interact seamlessly.

Cross-Chain Oracles: Implementation of cross-chain oracles enables Blockticity to access and verify data from multiple blockchain networks, enhancing the breadth and reliability of supply chain information.

2. Integration with Blockchain Explorers and Data Marketplaces: Blockticity's system is designed for transparency and accessibility:

Blockchain Explorer Compatibility: Full integration with Avalanche's native blockchain explorer, allowing users to easily track and verify COA NFTs and associated transactions.

Custom Data Marketplace: While not operating a traditional NFT marketplace, Blockticity provides a specialized data marketplace where authenticated supply chain data can be securely accessed and traded.

API for Third-Party Explorers: Blockticity offers robust APIs that allow third-party blockchain explorers to index and display its COA NFTs and transaction data, increasing visibility and accessibility.

3. Seamless Interaction with Existing Systems: Blockticity prioritizes easy integration with current supply chain infrastructure:

ERP System Integration: Provides connectors and APIs for popular Enterprise Resource Planning (ERP) systems, allowing businesses to incorporate blockchain-based COAs into their existing workflows.

EDI Compatibility: Supports Electronic Data Interchange (EDI) standards, enabling seamless communication with legacy supply chain management systems.

Cloud Service Integration: Offers plugins and interfaces for major cloud service providers, facilitating easy adoption for businesses already leveraging cloud technologies.

4. Compatibility with IoT Devices and Emerging Technologies: Blockticity's forward-looking design accommodates integration with cutting-edge technologies:

IoT Device Integration: Supports direct communication with IoT devices for real-time tracking and authentication of products throughout the supply chain.

AI and Machine Learning Compatibility: Provides interfaces for AI and machine learning models to analyze supply chain data, enabling predictive analytics and automated decision-making.

AR/VR Ready: Includes capabilities to support Augmented Reality (AR) and Virtual Reality (VR) applications, potentially allowing for immersive supply chain visualization and management experiences.

5. Standardization and Protocol Support: To ensure wide-ranging compatibility, Blockticity adheres to and supports various standards:
Implementation of common interoperability protocols like Cosmos IBC (Inter-Blockchain Communication) protocol.
Support for industry-standard supply chain communication protocols and data formats.
Compliance with emerging blockchain interoperability standards to future-proof the system.

By implementing these comprehensive interoperability features, Blockticity ensures that its L1 solution can seamlessly interact with a wide range of blockchain networks, traditional supply chain systems, and emerging technologies. This approach not only enhances the utility and adoption potential of Blockticity's platform but also positions it as a versatile and future-ready solution in the evolving landscape of blockchain-based supply chain management.

1. A blockchain-based system for verifying Certificates of Authentication (COAs) in supply chain management, compliant with ASTM D8558-24 and relevant ISO standards, comprising:
a custom Layer 1 (L1) blockchain platform built on Avalanche;
a dual-token model featuring a utility token (BTIC) and a stablecoin (BCOA);
a tool for minting COAs as Non-Fungible Tokens (NFTs);
an AI-powered verification system for authenticating COAs; and
integration capabilities with various tracking devices and existing supply chain systems.

2. The system of claim 1, wherein the COA minting process includes assigning unique identifiers, metadata, and digital signatures, with minting fees paid in BCOA tokens, in accordance with ASTM D8558-24 guidelines.

3. The system of claim 1, wherein the authentication process includes AI-powered preliminary analysis, examining smart contracts, verifying metadata, confirming digital signatures, and checking transaction history, adhering to ISO/IEC 27001 information security standards.

4. The system of claim 1, further comprising customizable privacy settings, enhanced regulatory compliance features, and industry-specific optimizations, in line with ISO 28000 supply chain security management standards.

5. The system of claim 1, further comprising support for B2B and B2C transactions in supply chain management, including inbound and outbound transfer capabilities, compliant with ISO 9001 quality management standards.

6. The system of claim 1, wherein the implementation adheres to ISO 22301 business continuity management standards to ensure resilience in supply chain operations.
